(19) United States
(12) Patent Application Publication
(10) Pub. No.: US 2019/0122256 A1
(43) Pub. Date: Apr. 25, 2019

(54) PREDICTING USER INTERACTION WITH PREVIOUSLY ACCESSED THIRD-PARTY CONTENT

(71) Applicant: Google Inc., Mountain View, CA (US)

(72) Inventors: Nathan Peter Lucash, San Francisco, CA (US); Fred Bertsch, Belmont, CA (US); Eu-Jin Goh, Palo Alto, CA (US)

(73) Assignee: Google Inc., Mountain View, CA (US)

(21) Appl. No.: 13/900,254

(22) Filed: May 22, 2013

(51) Int. Cl. G06Q 30/02

(52) U.S. Cl. CPC G06Q 30/0246

(57) ABSTRACT

System and method for remarketing based on a prediction of how a user will interact with previously accessed third-party content based on how the user perceives content viewed on a third-party content provider's web property is presented. A remarketing system communicates a tag for triggering a user identifier and a computer executable code to a user via a third-party content provider system when the user computer accesses content on the third-party content provider system. The computer executable code measures user activities relating to how the user perceives the content. The remarketing system predicts how the user will react to previously accessed third-party content as a function of these measurements. In response to an affiliate web property requesting a third-party content, the remarketing system determines whether to select the previously accessed third-party content. Further, the remarketing system may allow the third-party content provider's bid for selection of the previously accessed third-party content to be adjusted to increase the likelihood of the previously accessed third-party content being selected.

### BACKGROUND

In on-line retailing, retailers (which may include one or more individuals, companies and/or other groups, whether for profit or nonprofit) offer products, services and/or information (“offerings”) for acquisition via the retailer's web property, such as a website. Online retailers may promote or publicize (e.g., advertise”) their products and/or services on the web properties of other entities (“affiliates”). This practice may include the use of information relating to the activities the user engaged in while accessing the retailer's web property.

In general, retailers compete with other retailers (“competitors”) for publicizing space on an affiliate's web property. The third-party contents (such as advertisements”) of the various retailers are ranked to determine the order they are to be presented on an affiliate's web property. The third-party contents' rank may depend, in part, on the information relating to the activities of the user while on the retailer's web property.

### SUMMARY

An example of a method for the selection of a remarketing third-party content for communication to a user via an affiliate web property (“remarketing selection method”) includes, but is not limited to, communicating a computer executable code to a third-party content provider web property, wherein the third-party content provider web property is associated with content and wherein the computer executable code is configured to generate a measurement of a user activity relating to a user's perception of the content; receiving the measurement from the third-party content provider web property; and generating a prediction of how the user will interact with third-party content as a function of the user activity.

The remarketing selection method may further include receiving a request for a third-party content from the affiliate web property in response to the user accessing the affiliate web property and determining whether to select the third-party content as a function of the prediction of how the user will interact with the third-party content. In one example, the content may include a first third-party content and may include second third-party content related to the content. In another example, the measurement may be received from the third-party content provider web property via the computer executable code. In a further example, generating the prediction of how the user will interact with the third-party content includes generating a prediction of a click through rate and/or a click to accept rate. In the remarketing selection method, the user activities may include how the user interacts with the third-party content provider web property and/or how long the content was capable of being perceived by the user.

An example of a method for adjusting an third-party content provider bid for placement of a third-party content on an affiliate web property (“third-party content provider bid adjusting method”) includes, but is not limited to communicating a computer executable code to a third-party content provider web property, wherein the third-party content provider web property is associated with content and wherein the computer executable code is configured to generate a measurement of a user activity relating to the user's perception of the content; receiving the measurement from the third-party content provider web property; generating a prediction of how the user will interact with the third-party content as a function of the user activity; generating a ranking value for the third-party content as a function of the prediction; and adjusting the third-party content provider bid as a function of the ranking value.

An example of a remarketing system configured to select a third-party content for communication to a user via an affiliate web property, includes, but is not limited to, an interface configured to communicate a computer executable code to a third-party content provider web property, wherein the computer executable code is configured to enable the third-party content provider web property to generate a measurement of a user activity relating to a user's perception of a content associated with the third-party content provider web property and further configured to receive the measurement from the third-party content provider web property and a prediction module configured to generate a prediction of how the user will interact with the third-party content as a function of the user activity. The remarketing system may further include a code module configured to generate the computer executable code and/or a selection module configured to determine whether to select the third-party content as a function of the prediction of how the user will interact with the third-party content.

In one example, the interface may be further configured to receive a request for an third-party content from the affiliate web property in response to the user accessing the affiliate web property, to place the remarketing system in communication with the user via a user computer and/or receive the measurement from the third-party content provider web property via the computer executable code. In one example, the prediction module is further configured to generate a click through rate and/or a click to accept rate. In one example, the user activity includes how the user interacts with the third-party content provider web property and/or how long the content was capable of being perceived by the user.

An example of a system for adjusting an third-party content provider bid for placement of a third-party content on an affiliate web property (“bid adjustment method”), includes, but is not limited to, an interface configured to communicate a computer executable code to an third-party content provider web property, wherein the computer executable code is configured to generate a measurement of a user activity relating to a user's perception of a content associated with the third-party content provider web property; a prediction module configured to generate a prediction of how the user will interact with the third-party content as a function of the user activity; a ranking module configured to generate a ranking value for the third-party content as a function of the prediction and a bid module configured to adjust the third-party content provider bid as a function of the ranking value.

These as well as other aspects, advantages, and alternatives will become apparent to those of ordinary skill in the art by reading the following detailed description, with reference where appropriate to the accompanying drawings. Further, it should be understood that the disclosure provided in this summary section and elsewhere in this document is intended to discuss the embodiments by way of example only and not by way of limitation.

### BRIEF DESCRIPTION OF THE DRAWINGS

In the accompanying figures, like reference numerals refer to identical or functionally similar elements throughout the separate views.

FIG. 1 is a block diagram of an illustrative remarketing environment.

FIG. 2 is a block diagram of an illustrative third-party content provider system.

FIG. 3 is a block diagram of an illustrative user computer.

FIG. 4 is a block diagram of an illustrative affiliate system.

FIG. 5 is a block diagram of an illustrative remarketing system.

FIG. 6 is a flow chart of an illustrative method for communicating a remarketing third-party content to an affiliate web property.

FIG. 7 is a flow chart of an illustrative method for predicting how a user will interact with a remarketing third-party content.

FIG. 8 is a flow chart of an illustrative method for identifying a user.

FIG. 9 is a flow chart of an illustrative method for determining whether a remarketing third-party content is selected for communication to an affiliate web property.

Elements in the figures are illustrated for simplicity and clarity and have not necessarily been drawn to scale. For example, the dimensions of some of the elements in the figures may be exaggerated relative to other elements. Further, the apparatus and method components have been represented, where appropriate, by conventional symbols in the drawings.

### DETAILED DESCRIPTION

### Overview

Third-party content promoting bids can be modified since according to the present invention a third-party content system can determine that a user has looked at specific media contents for a period of time on the retailer's website. This knowledge may change the overall likelihood that the user will come back to buy something. Moreover, when the user has accessed two product pages on website of the retailer or of the third-party content provider (“such as an advertiser”), and for example has spent 30 seconds on the first page and two seconds on the second page. The third-party content system should probably show pictures from the first page when showing third-party contents to the user.

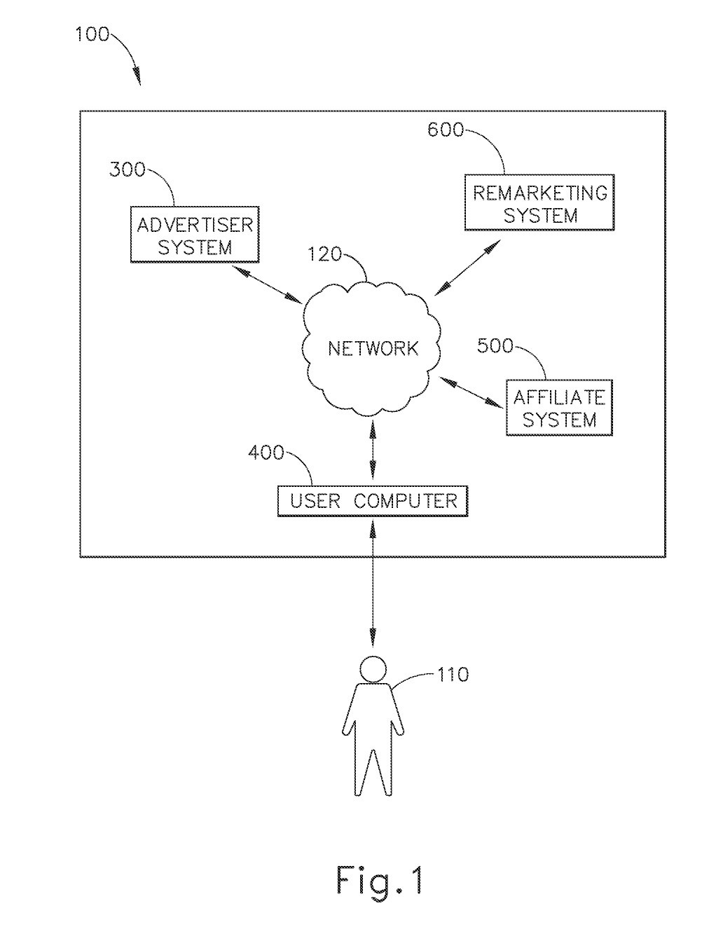

FIG. 1 depicts an example of an environment for remarketing third-party contents (“remarketing environment”) 100. The remarketing environment 100 is one that enables a third-party content provider to present remarketing, that is previously accessed or viewed, third-party contents to an entity (“user”) who has previously accessed or viewed the third-party content provider's web property on a different web property. The remarketing environment 100 generally includes a network 120, a third-party content provider system 300, a user computer 400, an affiliate system 500 and a remarketing system 600. The user 110 interacts with the remarketing environment via the user computer 400.

The third-party content provider system 300, user computer 400, affiliate system 500 and the remarketing system 600 are generally in communication with each other via the network 120. The network 120 enables third-party content provider system 300, user computer 400 and remarketing system 600 to operate in a networked environment having logical connections among them. In one example, the network 120 includes the Internet. Third-party content provider system 300, user computer 400, affiliate system 500 and the remarketing system 600 may be in communication with the network directly or indirectly via one or more communication systems. In another example, third-party content provider system 300, user computer 400 and remarketing system 600, or any combination thereof, may not be connected by the network 120 or any other means, but instead, data may be migrated via any computer readable medium.

Third-party content provider system 300, user computer 400 and/or remarketing system 600 may be in communication with the network 120 directly or indirectly via one or more communication systems. These communication systems include, alone or in combination, wired and/or wireless communication technologies. Examples of wired communication technologies include, but are not limited to twisted pair wire, coaxial cable and optical cable. Examples of wireless communication technologies include, but are not limited to, terrestrial microwave, communication satellites, cellular systems, PCS systems, wireless local area networks (WLAN), infrared communications and global area networks (GAN).

The remarketing environment 100 enables the remarketing system 600 to predict how a user will interact to a remarketing third-party content by taking into account certain user activities related to content, such as third-party content provider offerings viewed on system 300. Third-party content provider system 300 is generally accessed by the user 110 through the user computer 400.

In order to measure these user activities, the remarketing system 600 communicates a computer executable code and a tag to third-party content provider system 300. The code enables third-party content provider system 300 to measure user activities indicating the user's perception of content presented by third-party content provider system 300. When the user 110, via the user computer 400, accesses third-party content provider system 300, the third-party content provider has the computer executable code executed so that the user activities can be monitored and measured.

For situations in which the systems discussed here (i.e. systems 300 and 600) collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating parameters (e.g., demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

In addition, when the user 110 accesses the third-party content provider system 300, the third-party content provider downloads the tag onto the user computer 400. In response, the user computer 400 accesses the remarketing system 600. The remarketing system 600 communicates data that identifies the user 110. This may be in the form of a cookie. This user identifier allows the user computer 400 to be identified by other systems.

Third-party content provider system 300 communicates the measurements to the remarketing system 600 periodically as the user 110 is accessing third-party content provider system 300 or after the user 110 has terminated communications. The remarketing system 600 generates a prediction of how the user 110 will interact with a remarketing ad as a function of the measurements.

When the user 110 accesses an affiliate system 500 with promoting space to fill, the affiliate system 500 identifies the user computer 400 by accessing the user identifier stored thereon. The affiliate system 500 communicates the user identifier and a request for a third-party content to the remarketing system 600.

In response, the remarketing system 600 determines whether to select the remarketing ad for communication to the affiliate system 500. This determination is made as a function of the prediction of how the user 110 will interact with the remarketing third-party content and other factors.

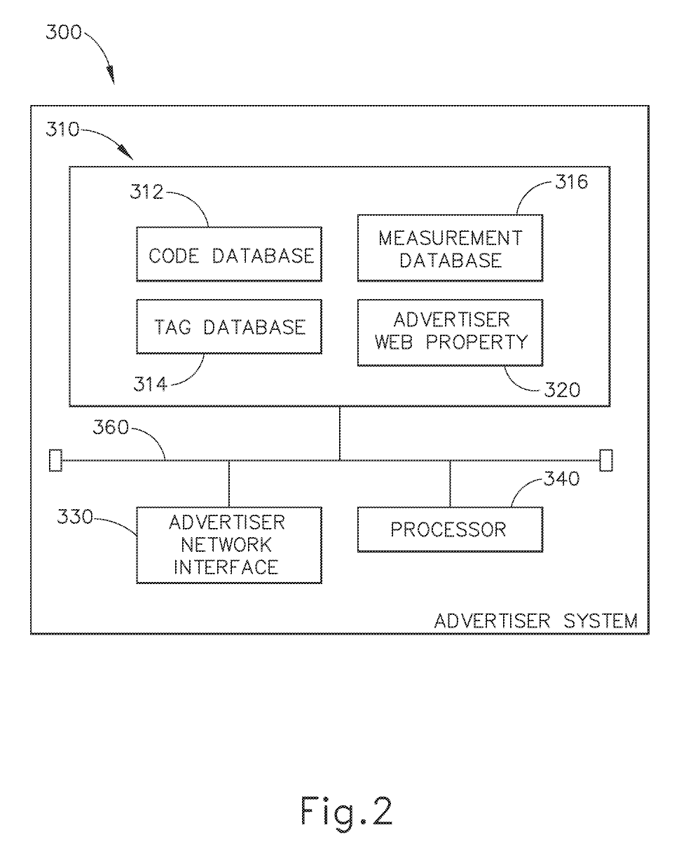

Third-party content provider system 300, user computer 400, affiliate system 500 and the remarketing system 600 are shown in FIGS. 2, 3, 4 and 5 respectively. With reference to FIGS. 2, 3, 4 and 5, third-party content provider system 300, user computer 400, affiliate system 500 and the remarketing system 600 each generally include a processor 340, 440, 540 and 640, respectively. Processors 340, 440, 540 and 640 include one or more devices capable of processing digital information, such as a microprocessor. The processors 340, 440, 540 and 640 may be implemented as shown in FIGS. 2, 3, 4 and 5. However, the processors 340, 440, 540 and 640 may be implemented in one or more devices located in, near and/or remote from third-party content provider system 300, user computer 400, affiliate system 500 and/or remarketing system 600.

Third-party content provider system 300, user computer 400, affiliate system 500 and remarketing system 600 each generally include a memory 310, 410, 510 and 610, respectively. Memories 310, 410, 510 and 610 include any device or devices capable of storing computer readable instructions and/or data. Memories 310, 410, 510 and 610 may include magnetic media like a floppy disk that may be read by a floppy disk drive, a hard disk drive and magnetic tape; optical media like a Compact Disc (CD), a Digital Video Disk (DVD), and a Blu-ray Disc which may be read by an optical disk drive; and solid state memory such as random access memory (RAM), flash memory, and read only memory (ROM). The memories 310, 410, 510 and 610 may be implemented as shown in FIGS. 2, 3, 4 and 5. However, the memories may be implemented in one or more devices located in, near and/or remote from third-party content provider system 300, user computer 400, affiliate system 500 and/or remarketing system 600.

The affiliate system 500 may include a request generation module 514 stored in memory 510. The remarketing system 600 may include code module user identifier module 624, 612, prediction module 614 stored in memory 610. The remarketing system 600 may further include a selection module 616, bid module 618 and/or ranking module 620 in the memory 610. Modules 514, 612, 614, 616, 618, 620 and 624 may include computer executable software. Alternatively, modules 514, 612, 614, 616, 618, 620 and 624 may be implemented apart from memories 510 and 610, respectively. In this case, the modules 514, 612, 614, 616, 618, 620 and 624 may include separate devices, which may include a processor and/or memory in which the computer readable software is stored.

Third-party content provider system 300, user computer 400, affiliate system 500 and the remarketing system 600 each generally include one or more interfaces. Third-party content provider system 300 may include a third-party content provider network interface 330. The user computer 400 may include a system interface 430. The affiliate system 500 may include an affiliate network interface 530. The remarketing system 600 may include a remarketing network interface 630. These interfaces 330, 430, 530 and 630 include input and output devices and computer executable software that enable third-party content provider system 300, user computer 400, affiliate system 500 and remarketing system 600 to communicate with network 120 and thus to each other.

The interfaces 330, 430, 530 and 630 generally include devices and/or software capable of generating, transmitting and receiving electrical and/or electromagnetic signals. For example, the interfaces 330, 430, 530 and 630 may include a wired device, such as a modem and/or a wireless device, such as a radio. The radio may communicate according to various communications protocols such as, WiMAX™, 802.11 a/b/g/n, Bluetooth™, 2G, 3G, and 4G.

Third-party content provider system 300, user computer system 400, affiliate system 500 and the remarketing system 600 each generally include a bus 360, 460, 560 and 660, respectively. The buses 360, 460, 560 and 660 include a subsystem that transfers data between the components of third-party content provider system 300, user computer system 400, affiliate system 500 and the remarketing system 600, respectively.

Referring to FIGS. 1 and 2, third-party content provider 300 generally includes a memory 310, third-party content provider network interface 330, processor 340 and a bus 360. Memory 310, third-party content provider network interface 330, and processor 320 may be in communication with each other via bus 360. Third-party content provider 300 generally includes hardware and/or software that enable delivery of the third-party content provider web property 320 via the network 120.

The third-party content provider network interface 330 is in communication with the remarketing system 600 via network 120. The third-party content provider network interface 330 receives the computer executable code and tag from the remarketing system 600. The third-party content provider network interface 330 is also in communication with the user computer 400 and communicates the computer executable code and tag to the user computer 400 in response to the user computer 400 requesting access to the third-party content provider web property 326. The third-party content provider network interface 330 may also receive measurements of user activities taken by the user computer 400 and communicate these measurements to the remarketing system 600.

The memory 310 generally includes a code database 312, tag database 314 and a third-party content provider web property 320. The memory 310 may further include a measurement database 316. Third-party content provider web property 320 may, for example, include a web site. This web site may include one or more web pages. The code database 312 stores the computer executable code received from the remarketing module 600. The tag database 314 stores the tag received from the remarketing module 600. The measurement database 316 stores data relating to the measurements of user activities received from the user computer 400.

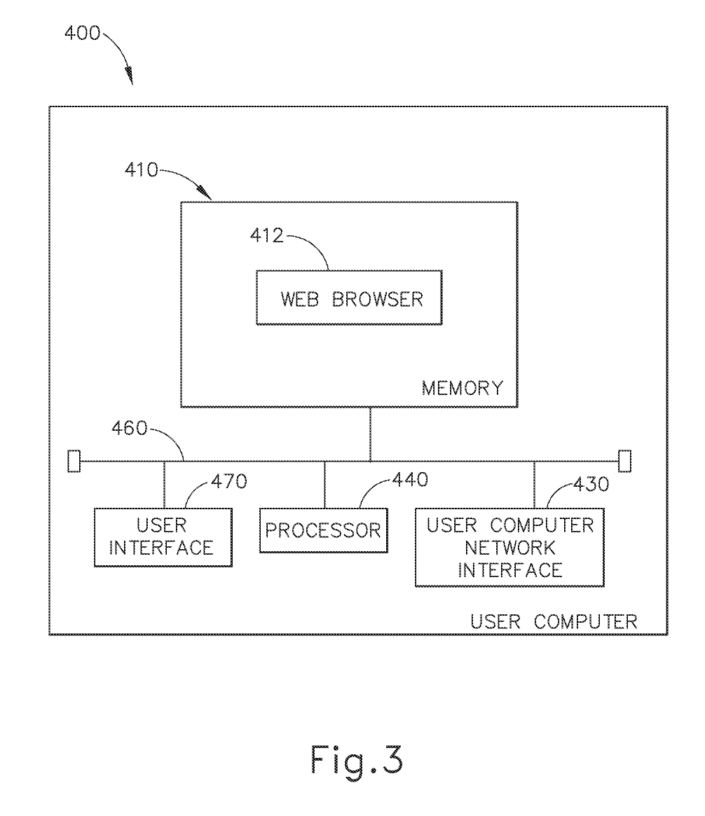

Referring to FIGS. 1 and 3, the user computer 400 generally includes a memory 410, processor 440, user computer network interface 430 and user interface 470. Memory 410, processor 440, user computer network interface 430 and user interface 470 may be in communication with each other via bus 460.

The memory 410 generally stores a web browser 412. The web browser 412 includes computer executable software used for accessing sites and information on the World Wide Web (“WWW”) and may be executed by processor 440. The web browser 412 generally retrieves, presents and traverses information resources, such as a web property. The web browser may access a web property according to the web property's uniform resource locator (“URL”). Examples of web browsers include, Internet Explorer®, Safari®, Firefox® and Google Chrome®.

The user interface 470 enables the user 110 to interact with third-party content provider web property 320 and the affiliate web property 516 via user computer 400. The user interface 470 includes input devices, output devices and/or combinations of the two. Input devices include devices through which data and/or computer executable software may entered into the user computer 400, either automatically or by the user 110 who enters commands and data. Input devices may include: an electronic digitizer or drawing board; a barcode reader, an RFID reader, a debit card reader, or any near-field communication (“NFC”) reader; a microphone; an image capture device such as a camera, a video camera, or a digital flatbed or sheet-fed scanner; a keyboard, a numeric pin pad, any device which has a series of depressible keys; a pointing device, such as a mouse, a trackball or a touch pad; any memory device, any Bluetooth™ enabled device, or any networked device able to generate and transmit a signal. Other input devices may include a joystick, game pad, satellite dish, an instrument, a sensor, and the like. The user interface 470 may also include output devices including devices through which data may be communicated to a user such as, a monitor, printer and speaker. The user interface 470 may include a combination input/output device such as a touch screen.

The user computer network interface 430 may communicate requests and data to and receive a user identifier (which may be in the form of a cookie) and perhaps other data from the remarketing system 600 via network 120. The user identifier may be stored in memory 410. The user computer network interface 430 may also communicate with third-party content provider system 300 and the affiliate system 500 via the network 120. In general, the user computer network interface 430 utilizes the web browser 412 to request access to third-party content provider system 300 and the affiliate system 500. The web browser 412 may render the resources communicated from third-party content provider system 300 and the affiliate system 500 to the user computer 400 via a user interface 470, such as a monitor.

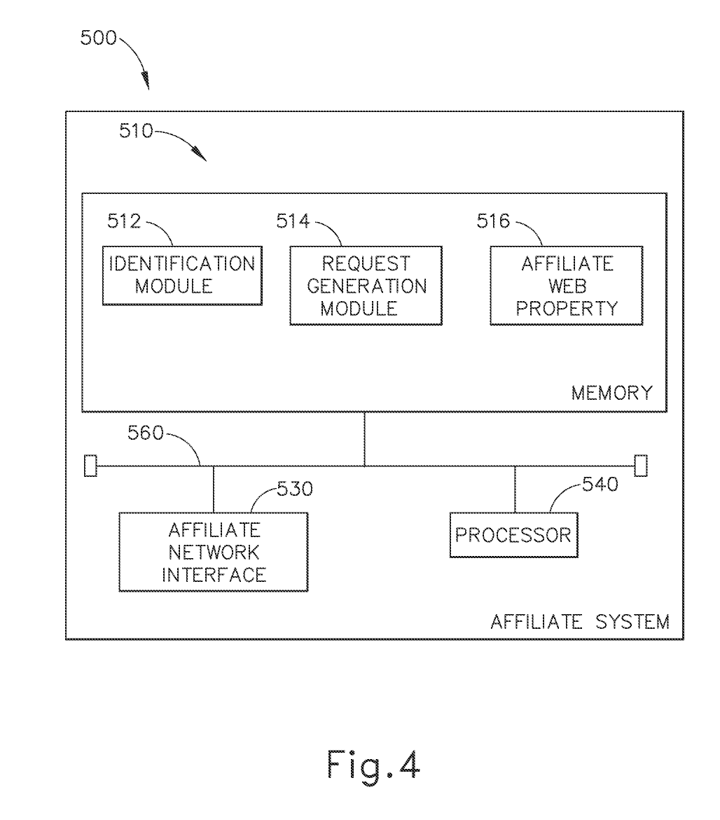

Referring to FIGS. 1 and 4, the affiliate system 500 generally includes a memory 510, affiliate network interface 530, processor 540 and bus 560. Memory 510, affiliate network interface 530 and processor 540 may be in communication with each other via bus 560. The affiliate system 500 generally includes hardware and/or software that enable delivery of the affiliate web property 516 via the network 120.

The memory 510 generally includes an identification module 512, a request generation module 514 and an affiliate web property 516. The affiliate web property 516 may, for example, include a web site. This web site may include one or more web pages. The identification module 512 accesses the user computer 400 to look for and obtain the user identifier from the user computer 400 in response to a request from the user computer 400 to access to the affiliate web property 516. The request generation module 514 generates a request for a third-party content in response to a request from the user computer 400 to access the affiliate web property 516.

The affiliate network interface 530 is in communication with the remarketing system 600 via network 120. In response to a request for access to the affiliate web property 516 from the user computer 400, the affiliate network interface 530 communicates the request for a third-party content and the user identifier to the remarketing module 600. In response, the affiliate interface 530 receives a third-party content from the remarketing system 600. The third-party content may include a remarketing third-party content. The affiliate network interface 530 may then communicate the third-party content to the user computer 400 via the web browser 412.

In the examples shown in FIGS. 1, 2 and 4, third-party content provider system 300 and the affiliate system 500 are shown as separate systems. However, the third-party content provider web property 320 and the affiliate web property 516 may be included in a single system. The third-party content provider web property 320 and the affiliate web property 516 may, for example, share one or more memories, processors and interfaces or any combination thereof.

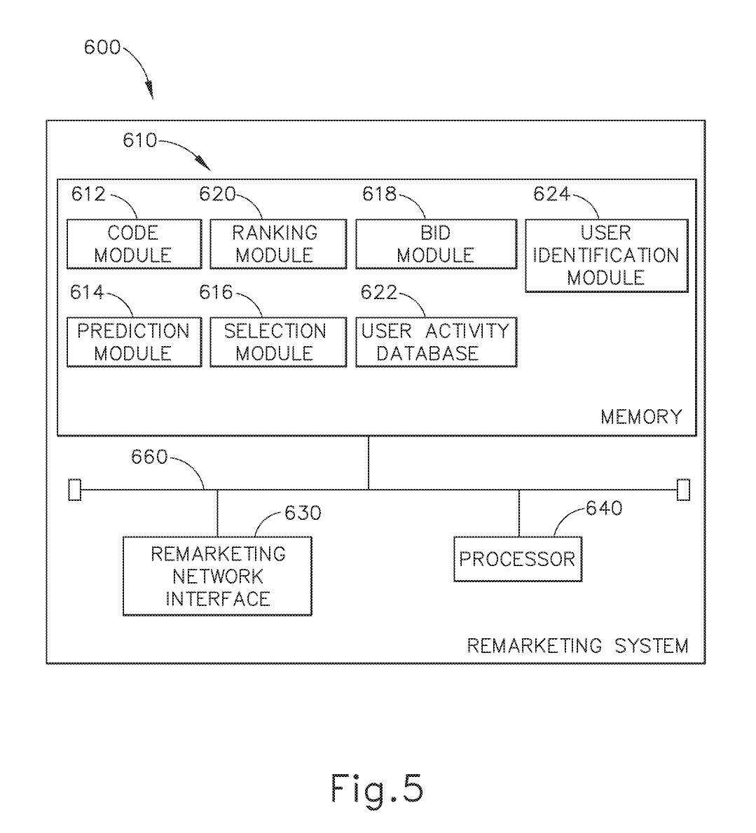

Referring to FIGS. 1 and 5, the remarketing system 600 generally includes a memory 610, remarketing network interface 630, processor 640 and bus 660. The memory 610, remarketing network interface 630 and processor 640 may be in communication with each other via bus 660.

The memory 610 generally includes a user activity database 622, code module 612 and prediction module 614. The memory 610 may further include a selection module 616, a bid module 618 and/or a ranking module 620.

The user activity database 622 includes a list of the user activities that may be used to determine the user's perception of content associated with a web property. The user's perception of a web property may indicate the user's interest in the content and, thus how the user may interact with a remarketing third-party content. User activities include how long the users views the content, how long the content is in focus, how long a particular image of the content is visible, how the user manipulates the web property, the order in which images of the content are viewed and how many images are viewed. User activities relating to how the user manipulates the content include, manipulating the size and orientation of one or more images. The user activities used to determine how a user may react to a remarketing third-party content may be selected by the third-party content provider or the remarketer.

In one embodiment, an executable code, such as JavaScript™ code, running in web browser 412, is configured to measure where the user is spending his/her time, and how much attention he/she is focusing on each part of the product. For example, if there are a lot of interactions with the technical specifications of a product, the code can assume that the user is going to remember the specs. If the user views the product from the left side for a while, then we assume that the user will know what that side looks like.

Once the code understands what the user has done, it is configured to send a log of that information back to the server. This can include detailed information on what interactions happened and when, or it can contain summaries of the interactions. For example, it could have detailed timestamps of each mouse movement and click, or it could have an estimate of how long the user looked at each picture of the product. The server may store a summary of this information, record an estimate of how well the user remembers the product and how long the user will remember it, and include the information that the user was most interested in. The summary can have more information if space is available. Alternatively, it can be compressed even more if needed.

The code module 612 generates computer executable code that enables third-party content provider system 300 to measure the selected user activities. The code module 612 may also generate a tag, which is to be communicated to the user computer 400 via third-party content provider system 300. The tag directs the user computer 400 to the remarketing system 600. In response to a communication from the user computer 400, the user identifier module 624 generates and communicates data relating to the identity of the user 110.

The prediction module 614 receives the measurements of the selected user activities from third-party content provider system 300. The prediction module 614 uses these measurements to predict how the user may interact with a remarketing third-party content that relates to the content associated with the third-party content provider web property 320. Predictions of how the user will interact with the remarketing third-party content may be used to adjust predictions of click through rate and/or click to accept rate. These predictions may be stored in the prediction module 610, elsewhere in memory 610 or in a separate memory. Alternatively, the predictions may be made on the web browser side.

When the remarketing system 600 receives a request for a third-party content from the affiliate system 500, the selection module 616 selects a third-party content for the affiliate system 500 from among a plurality of third-party contents from many different third-party content providers. To do this the ranking module 620 generates a number (“ranking value”) for each potential third-party content. The ranking value may depend from one or more factors, such as the amount the third-party content provider is willing to pay for selection of the third-party content provider's remarketing third-party content (“advertiser bid”), quality of the third-party content, the affiliate web property 516 on which the third-party content is to be displayed and the potential for the third-party content to create revenue. One or more of these factors may be affected by the user activity measurements. In one example, the third-party content with the highest ranking value is selected. In this case, the remarketing third-party content will be selected if it has the highest ranking value.

The bid module 618 enables the third-party content provider bid to be adjusted so that the ranking value of the third-party content provider's remarketing third-party content is increased and thus, the remarketing third-party content has a greater chance of being selected. The remarketing system 600 may communicate the selected third-party content to the affiliate system 500 via the remarketing network interface 630. The third-party content may include the remarketing third-party content.

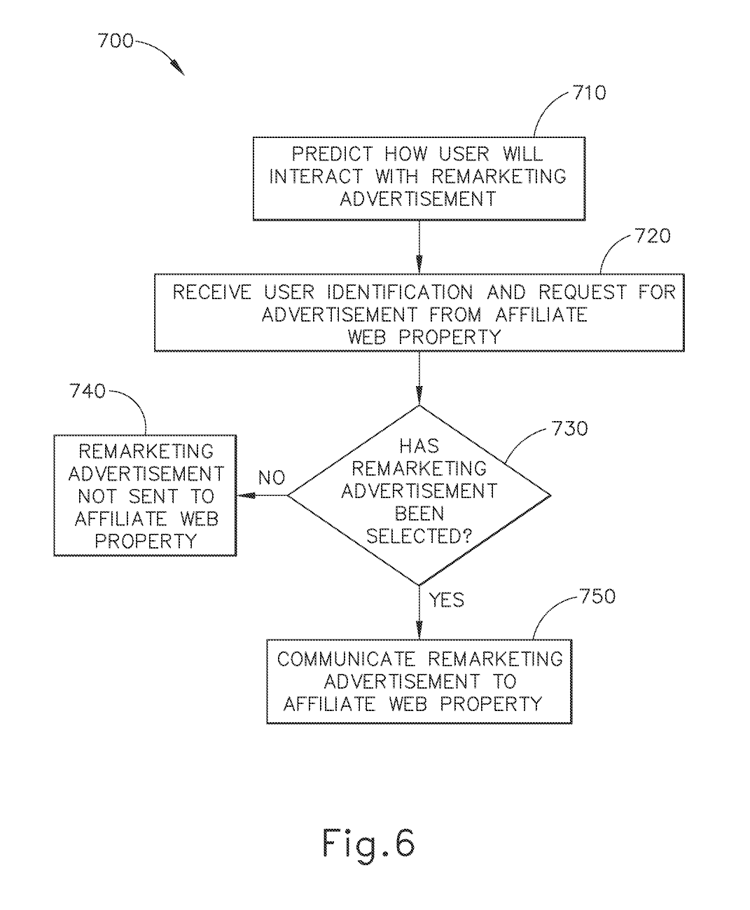

FIG. 6 depicts a method 700 for communicating a remarketing third-party content to an affiliate web property 516. In the example shown in FIG. 6, with reference to FIG. 4, the method 700 includes predicting how a user 110 will interact with a remarketing third-party content in step 710, receiving a user identifier and a request for a third-party content from the affiliate web property 516 in step 720, determining whether the remarketing third-party content has been selected in step 730, communicating the remarketing third-party content to the affiliate web property 516 if the remarketing third-party content has been selected, step 750, and not communicating the remarketing third-party content to the affiliate web property 516 if the remarketing third-party content has not been chosen in step 740.

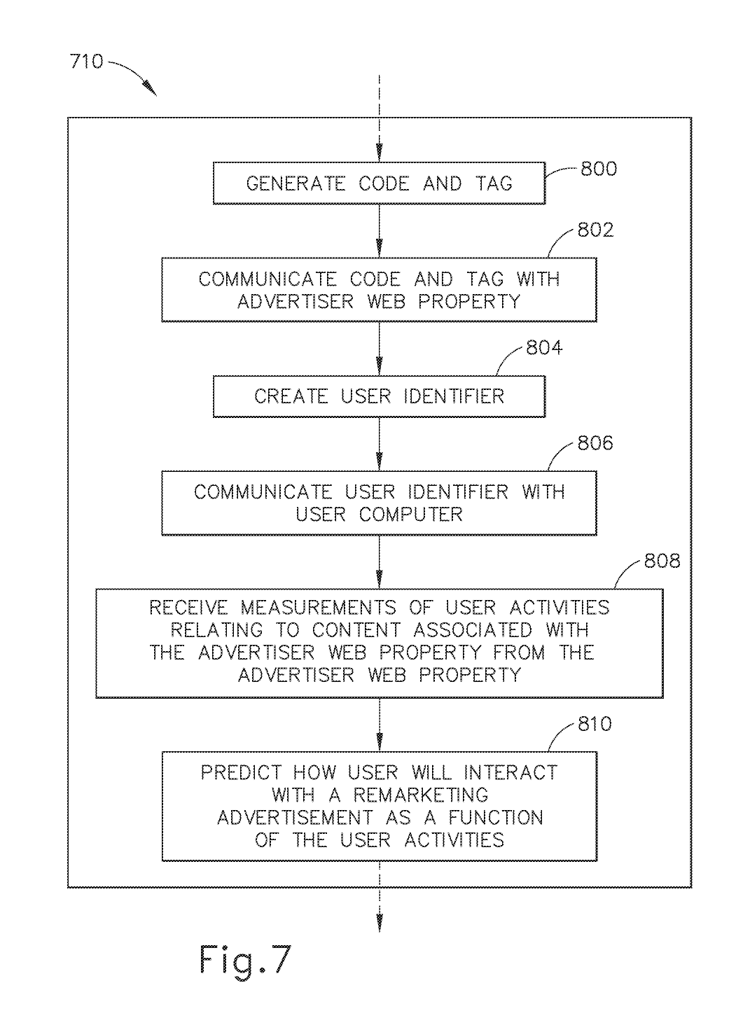

As shown in FIG. 7, with reference to FIGS. 1, 2 and 3, the step of predicting how a user 110 will interact with a remarketing third-party content may include the following: generating a code and tag in step 800, communicating the code and tag with the third-party content provider web property 320 in step 802, creating a user identifier 804, communicating the user identifier to the user computer 400 in step 806, receiving one or more measurements of one or more user activities relating to content associated with the third-party content provider web property 320 from the third-party content provider web property 320 in step 808 and predicting how the user 110 will interact with a remarketing third-party content as a function of the user activities in step 810.

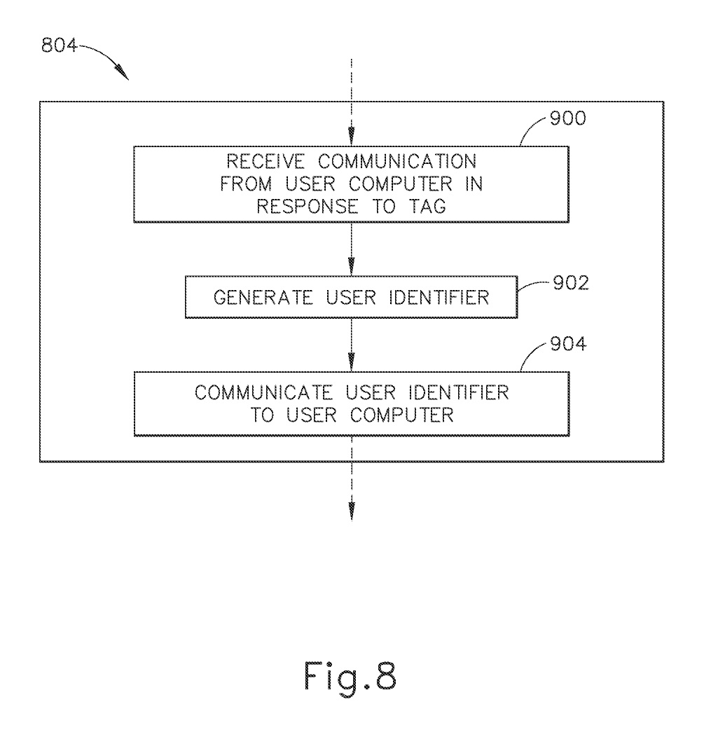

As shown in FIG. 8, with reference to FIG. 3, the step of creating a user identifier 804 may include receiving a communication from the user computer 400 in response to the tag in step 900, generating a user identifier in step 902 and communicating the user identifier to the user computer 400 in step 904.

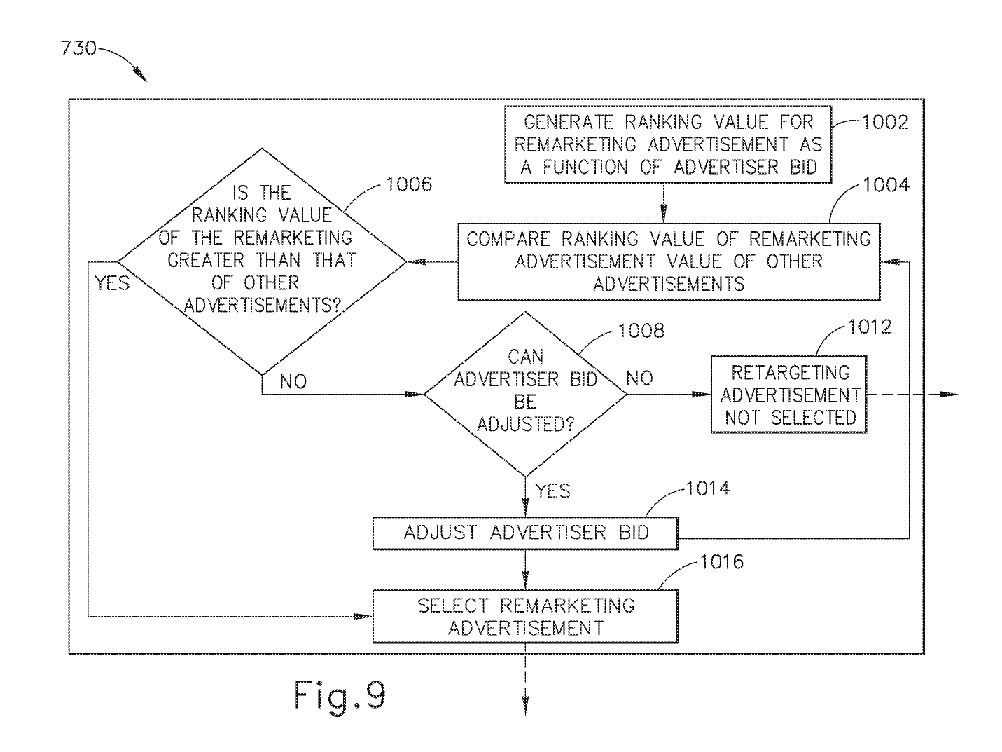

FIG. 9 depicts a method for determining whether a remarketing third-party content is selected. This method is based on an analysis of the user behavior. That is, for example, if the user is found to have studied a product for three (3) minutes, and then came back to it ten (10) minutes later to study it for another five (5) minutes, then third-party content system 300 may determine that the user is interested in the product and is likely to click on a corresponding ad. Moreover, if the user is found to have viewed the product briefly, then third-party content system 300 may determine that the user may not be interested in the product and may not remember it with a degree of accuracy.

Now referring back to FIG. 9, the step of determining whether a remarketing third-party content has been selected may include the following: generating a ranking value for remarketing third-party content as a function of an third-party content provider bid at step 1002, comparing the generated ranking value to the ranking values of remarketing third-party content values of other third-party contents at step 1004, determining whether the ranking value is greater than those other third-party contents in step 1006. In the affirmative, selecting a corresponding remarketing third-party content at step 1016. Otherwise, determining whether the third-party content provider bid can be adjusted at set 1008. In the affirmative, adjusting the third-party content provider bid at step 1014, and selecting the corresponding remarketing third-party content of step 1016. In the negative, the process of retargeting or remarketing third-party content is not selected or pursued, at step 1012.

In the foregoing specification, specific embodiments have been described. However, various modifications and changes can be made without departing from the scope of the claims herein. For example, method steps are not necessarily performed in the order described or depicted, unless such order is specifically indicated. Accordingly, the specification and figures are to be regarded in an illustrative rather than a restrictive sense, and all such modifications are intended to be included within the scope of the claims.

It will be appreciated that some embodiments may be comprised of one or more generic or specialized processors such as microprocessors, digital signal processors, customized processors and field programmable gate arrays (“FPGAs”) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

1. A method comprising:
downloading, by a client device and from a third-party content provider web property that presents content, computer executable code and a tag that identifies a remarketing system upon accessing the third-party content provider web property;
in response to downloading the tag, obtaining, by the client device and from the identified remarketing system, a cookie that identifies a particular user of the client device and the remarketing system;
executing, by the client device, the computer executable code, wherein the computer executable code causes a third-party content provider that provides the third-party content provider web property to generate a measurement of user activity representing the particular user's multiple different types of interaction with different portions of the third-party content provider web property by detecting (i) an order in which images of the content are viewed, (ii) how many images are viewed, and (iii) the particular user's manipulations of a size or the particular user's manipulation of an orientation of one or more images, and transmit the measurement of user activity and the cookie to the remarketing system;
in response to the executing of the computer executable code by the client device, accessing, by the client device, a web property, and detecting that the web property is different from the third-party content provider web property;
in response to the detecting, by the client device, that the web property accessed by the client device is different from the third-party content provider web property, providing, by the client device and to the remarketing system, (i) a request for content, and (ii) the cookie;
in response to the providing, by the client device, the request for content and the cookie to the remarketing system, receiving, at the client device and from the remarketing system, content that is provided by the third-party content provider and selected by the remarketing system based on the measurement of user activity that was transmitted with the cookie; and
presenting, at the client device, the content provided by the third-party content provider and selected by the remarketing system within the web property.

2. The method of claim 1, wherein the content that is provided by the third-content provider is data selected by the remarketing system by
receiving, from the client device, a request for third-party content along with a user identifier from an affiliate web property in response to the particular user accessing the affiliate web property;
providing, to the client device and by the remarketing system, particular third-party content;
determining that the particular third-party content has previously been accessed by the particular user;
predicting how the particular user will interact with the particular third-party content based on the determining that the particular third-party content has previously been accessed by the particular user; and
determining, based on the predicting, whether to communicate the previously accessed third-party content to the affiliate web property.

3. The method of claim 2 wherein predicting how the particular user will interact with the particular third-party content is based on the measurement of user activity.

4. (canceled)

5. The method of claim 3, wherein generating, by the third-party content provider, the measurement of user activity includes collecting timestamps associated with mouse movements, mouse clicks, time focused on a part of a product, interactions occur with technical specifications of the product, and user manipulations of the web property.

6. The method of claim 3, wherein predicting how the user will interact with the previously accessed third-party content includes generating a prediction of at least one of a click-through rate or a click-to-accept rate.

7. (canceled)

8. (canceled)

9. (canceled)

10. A system comprising:
one or more processors; and
memory for storing instructions executable by the one or more processors, the instructions used by:
a client device configured to:
download, from a third-party content provider web property that presents content, computer executable code and a tag that identifies a remarketing system upon accessing the third-party content provider web property;
in response to downloading the tag, obtain, by the client device and from the identified remarketing system, a cookie that identifies a particular user of the client device and the remarketing system;
execute the computer executable code, wherein the computer executable code causes a third-party content provider that provides the third-party content provider web property to generate a measurement of user activity representing the particular user's multiple different types of interaction with different portions of the third-party content provider web property by detecting (i) an order in which images of the content are viewed, (ii) how many images are viewed, and (iii) the particular user's manipulations of a size or the particular user's manipulation of an orientation of one or more images, and transmit the measurement of user activity and the cookie to the remarking system;
in response to the executing of the computer executable device, access, a web property, and detect that the web property is different from the third-party content provider web property;
in response to the detecting that the web property accessed by the client device is different from the third-party content provider web property, provide, to the remarketing system, (i) a request for content, and (ii) the cookie;
in response to the providing the request for content and the cookie to the remarketing system, receive, from the remarketing system, content that is provided by the third-party content provider and selected by the remarketing system based on the measurement of user activity that was transmitted with the cookie; and
present the content provided by the third-party content provider and selected by the remarketing system within the web property.

11. The system of claim 10 further comprising a prediction module configured to generate a prediction of how the user will interact with the previously accessed third-party content as a function of the measurement of user activity.

12. The system of claim 11 further comprising a selection module configured to determine whether to select the previously accessed third-party content based at least on the prediction.

13. (canceled)

14. (canceled)

15. (canceled)

16. The system of claim 10, wherein the prediction module is further configured to generate at least one of a click-through rate or a click-to-accept rate.

17. The system of claim 10, wherein the measurement of user activity includes how the particular user interacts with the third-party content provider web property.

18. The system of claim 10, wherein the measurement of user activity includes include how long the content was capable of being perceived by the particular user.

19. (canceled)

20. A non-transitory computer-readable medium storing instructions that, when executed, cause one or more processors to:
download, from a third-party content provider web property that presents content, computer executable code and a tag that identifies a remarketing system upon accessing the third-party content provider web property;
in response to downloading the tag, obtain, by the client device and from the identified remarketing system, a cookie that identifies a particular user of the client device and the remarketing system;
execute the computer executable code, wherein the computer executable code causes a third-party content provider that provides the third-party content provider web property to generate a measurement of user activity representing the particular user's multiple different types of interaction with different portions of the third-party content provider web property by detecting (i) an order in which images of the content are viewed, (ii) how many images are viewed, and (iii) the particular user's manipulations of a size or the particular user's manipulation of an orientation of one or more images, and transmit the measurement of user activity and the cookie to the remarking system;
in response to the executing of the computer executable device, access, a web property, and detect that the web property is different from the third-party content provider web property;
in response to the detecting that the web property accessed by the client device is different from the third-party content provider web property, provide, to the remarketing system, (i) a request for content, and (ii) the cookie;
in response to the providing the request for content and the cookie to the remarketing system, receive, from the remarketing system, content that is provided by the third-party content provider and selected by the remarketing system based on the measurement of user activity that was transmitted with the cookie; and
present the content provided by the third-party content provider and selected by the remarketing system within the web property.

21. The method of claim 1, wherein detecting multiple different types of user interactions with the third-party content provider web property that presents content includes detecting one or more of how long the user has viewed the content, how long the content is in focus, or how long a particular image of the content is visible.
